(19) United States
(12) Patent Application Publication
(10) Pub. No.: US 2007/0141403 A1
(43) Pub. Date: Jun. 21, 2007

(54) Portable battery unit featuring two standard AC type sockets, a carry handle, on/off switch, adapter/battery recharge socket, rechargeable battery, and inverter circuit

(76) Inventor: Willis Haywood, Raceland, LA (US)

Correspondence Address: Willis Haywood, P.O. Box 801, Raceland, LA, 70394, US

(21) Appl. No.: 11/315,422

(22) Filed: Dec. 21, 2005

(51) Int. Cl. H01M 2/10; H01M 10/46

(52) U.S. Cl. 429/7; 429/187

(57) ABSTRACT

An enclosure or casing that will contain a rechargeable battery which can be inserted from the side. An adapter and a battery recharge socket is attached to the side of the casing allowing for stored power. The back panel has AC type sockets which will operate anything that use AC power. The carry handle provides a means to transport the unit from place to place. An on and off switch allows the pack to be used at chosen times. An inverter circuit is applied inside to change the source of power form DC to AC. The base is square to allow user to position the unit without tilting. The difference in the design is the capability of changing DC current to AC current.

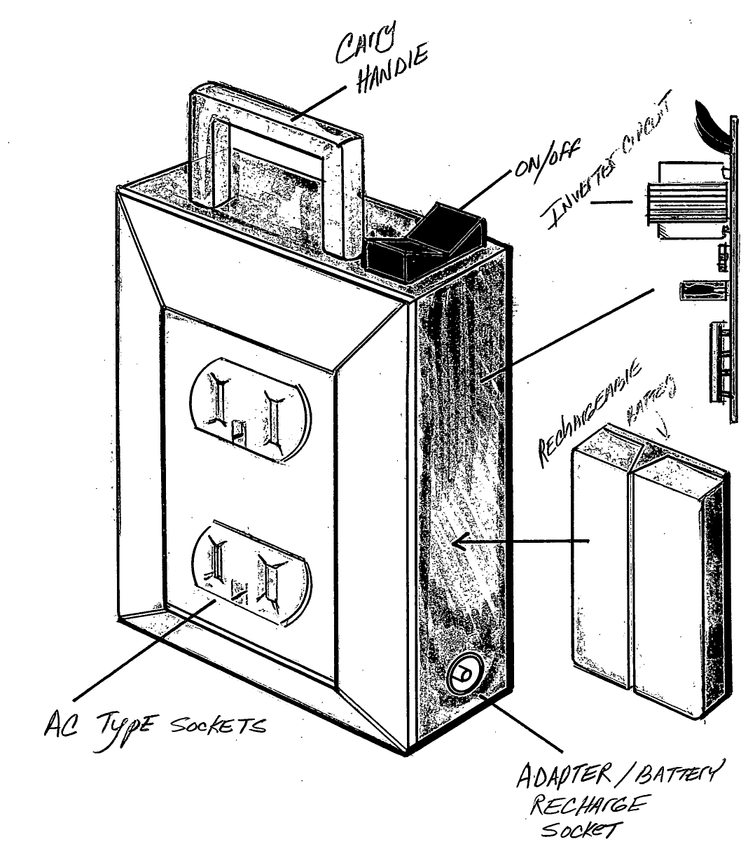

The following is a physical description of the “Firebug,” designed to characterize and define the working functions of the product which is a portable battery unit which features two standard AC type sockets, a carry handle, on/off switch, adapter/battery recharge sockets, rechargeable battery, and an inverter circuit. Based on the inventor's description and any pertinent additional research, typical use of the product, its basic design and production materials are considered.

The product has a combination of features which is a closure or box, “Firebug” with structures with the capability of inverting electricity when there is a blackout, when there is absence of electricity, or when another Katrina or Rita or other disaster occurs and there is a need for lights.

The firebug will be manufactured from plastic or fiberglass. It shall be rectangular in shape. It shall be silver in color.

Consideration is given to the cross-utilization and further modification of the product. Straightforward utilization would significantly expand the utility or the usability of the invention. A modification could accomplish this by either extending the original function.

Given the straightforward nature of the design of the “Firebug,” it is unlikely that any major technical modifications would be needed to bring the concept to production readiness.

Any concerns that may arise during the development of the “Firebug” should be amendable to resolution through normal product testing and refinement. After this process, we would anticipate the product could be produced routinely. Whether it would be feasible to do so from an economical standpoint shall be determined by potential manufacturers.

Given the descriptions of how the “Firebug” would function, and taking into consideration the questions facing further development of the proposed product, it is our tentative judgment that the idea is based on sound principals. Detailed diagrams and technical specifications remain to be drawn.

The design parameters for this product are open to current production processes and tooling. The materials specified are commonly available on the commercial level. Due to the Firebug's” very simple components, it should be no problem to produce from any technical standpoint. Existing assembly lines could easily be adapted for its speedy manufacture.

### Product Benefits and Advantages

In the case of the “Firebug” the primary benefits provided by the product include, but are not limited to, granting individuals a portable power source that will accept any standard AC power plug.

The “Firebug” will allow campers to cook a complete meal in the middle of the forest without striking a match.

The “Firebug” is an excellent choice for power outages and it is cheaper than a gas generator. It is a needed tool during natural disasters.

The product market for the “Firebug” is individuals that need a portable power source. Virtually every individual can benefit from updated design. This product would also appeal to those that enjoy outdoor activities, including campers and tailgaters.

In a market atmosphere where improvements to invaluable common products are popular on the shelves, particularly when backed by a household brand, manufacturers of batteries will profit from the offering of the “Firebug.”

Given the design advantages of the product, its utility and conveniences are immediately evident.

### Graphic Illustrations

The attached illustration highlights the major components of the design. The illustration draws attention to the “visual claims” of the product. From the layperson's point of view, it helps to establish the unique features of the invention compared to any known similar products. This graphic illustration is merely a representation of the idea, and not the artistic portrayer of the idea. The manufacturers and their design team ultimately determines the final product design.

### DESCRIPTION OF VIEWS OF THE DRAWING

The invention relates an enclosure or a casing that will house various components for its operation.

The embodiment of the invention is now described as referenced on the drawing submitted.
1. The drawing shows a side and back panel of the enclosure.
2. The AC Type Sockets shows a capability of the unit in its basic operations.
3. The Carry handle shows the unit is capable of portability. It is attached to the top of the enclosure.
4. The On/Off switch is attached to the top and allow switching as desired by the user.
5. Rechargeable battery. This is a part used with the design, which allows powering of the unit for usage. Placement of the battery will be from the side as indicated in this view.
6. Adapter/Battery recharge socket is located on the bottom-side and allows recharge of the battery when not in use.
7. Inverter Circuit is drawn in isolation of the battery enclosure unit to invert power from the battery source to AC. It is mounted to inside of case.

The following claims are asserted with the invention by the inventor.

1. A portable battery unit;

2. A battery unit with AC type adapter;

3. A battery unit with adapter/battery recharge sockets;

4. A battery unit with carry handle;

5. A battery unit with an on/off switch;

6. A battery unit with an inverter circuit;

7. A battery unit with a slot for rechargeable battery.
